(19) United States
(12) Patent Application Publication
(10) Pub. No.: US 2026/0213429 A1
(43) Pub. Date: Jul. 23, 2026

(54) TECHNIQUES FOR DEPLOYABLE-PANEL ANTENNAS

(71) Applicant: Viasat, Inc., Carlsbad, CA (US)

(72) Inventors: Kenneth V. BUER, Bluff City, TN (US); Thomas S. MESSENGER, Oro Valley, AZ (US)

(21) Appl. No.: 19/141,177

(22) PCT Filed: Dec. 18, 2023
(86) PCT No.: PCT/US23/84545

§ 371 Date: Jun. 19, 2025

Related U.S. Application Data
(60) Provisional application No. 63/476,138, filed on Dec. 19, 2022.

(51) Int. Cl. H01Q 21/06; H01Q 1/12; H01Q 1/28

(52) U.S. Cl. CPC H01Q 21/061; H01Q 1/1235; H01Q 1/288

(57) ABSTRACT

Methods, systems, and devices for deployable-panel antenna arrays are described. An antenna system, such as an antenna system of a communications satellite, may include panels that are rotatably deployable via one or more rotary joints. The panels may each include antenna elements of an antenna array on one face of the panels and, in some examples, solar elements to provide power for operating the antenna system on an opposite face of the panels. The panels may be stowed in a relatively compact configuration, which may be at least partially within a cross-sectional projection of a body portion (e.g., of a communications satellite), and may be deployed by rotating the panels about one or more coupling axes. In the deployed configuration, the panels may form a polygonal or circular shape, such that a surface area available for antenna elements, solar panels, or both, is greater than the cross section of the body.

### CROSS REFERENCES

The present Application for Patent is a 371 national phase filing of International Patent application No. PCT/US2023/084545 by Buer et al., entitled “TECHNIQUES FOR DEPLOYABLE-PANEL ANTENNAS” filed Dec. 18, 2023, which claims the benefit of U.S. Provisional Patent Application No. 63/476,138 by Buer et al., entitled “SYSTEMS AND METHODS FOR STOWING AND DEPLOYING SATELLITE ANTENNAS,” filed Dec. 19, 2022, each of which is assigned to the assignee hereof, and each of which is expressly incorporated by reference in its entirety herein.

### FIELD OF TECHNOLOGY

The present disclosure relates to communication systems, including techniques for deployable-panel antennas.

### BACKGROUND

Communication systems may include antennas that are configured to communicate information by way of wireless signaling. For example, a satellite may be configured with one or more antennas that support communications with or between terminals (e.g., gateway terminals, user terminals) of a ground segment. Performance of an antenna system may be relatively higher for relatively larger antennas. However, relatively large antennas may be associated with challenges, such as challenges for delivering satellites to an orbital slot (e.g., as a relatively large payload volume in a launch vehicle), or otherwise moving or locating relatively large antennas.

### SUMMARY

The described techniques relate to improved methods, systems, devices, and apparatuses for deployable-panel antennas. A communications device, such as a communications satellite, may be configured to communicate with or relay signals between other devices via wireless signaling using an antenna system of the communications device. For example, a satellite may be deployed in an orbital location or moving orbital configuration (e.g., a non-geostationary orbit (NGSO), such as a low Earth orbit (LEO) or a medium Earth orbit (MEO)), and may include an antenna system that implements a set of multiple antenna elements (e.g., direct-radiating antenna elements, a direct-radiating array) that, in some examples, may be configured to communicate signaling via one or more beamformed beams (e.g., receive beams, transmit beams) with the other devices. However, some implementations of such a set of antenna elements may occupy a relatively large surface area, including when such antenna elements are operated without a reflector.

Additionally, operation of such a set of antenna elements may be associated with relatively substantial power consumption, which may be supported by a relatively large solar array. In some cases, deploying such communications satellites may include enclosing a set of multiple such communications satellite within a fairing of a launch vehicle (e.g., a rocket), such that the communications satellites may be deployed from the fairing after launch of the launch vehicle into respective orbital paths at an altitude over Earth. Due to spatial constraints within the fairing, some implementations of communications satellites may have insufficient surface area to support a spatial distribution of antenna elements of an antenna array, or a relatively large solar array, or both.

In accordance with examples as disclosed herein, a communications satellite may include panels that are rotatably deployable to increase a surface area for implementing antenna elements (e.g., an array of antenna elements), solar elements (e.g., a solar array), or both. For example, such panels may each include a respective subset of the antenna elements of the communications satellite on one face of the panels and, in some examples, a respective set of solar elements to provide power for operating the communications satellite on an opposite face of the panels. For deployment, the panels may each be configured to rotate about a coupling axis (e.g., an axis extending from a body of the communications satellite) to a respective angular alignment. Thus, the panels may be stowed in a relatively compact configuration, which may be at least partially within a cross-sectional projection of a body of the communications satellite, and may be deployed in a deployed configuration (e.g., an expanded configuration, a circular configuration) associated with rotating the panels about the coupling axis. In the deployed configuration, the panels may form a polygonal or circular shape, such that a surface area available for antenna elements, solar panels, or both, is greater than the cross-sectional shape of the body portion, which may improve performance characteristics of the communications satellite.

In some cases, a body portion of such a communications satellite may also include a set of one or more antenna elements, or a set of one or more solar elements, or both.

Further, the panels, the body portion, or a combination thereof may include circuitry configured to operate the antenna elements (e.g., signal processing circuitry, beamforming circuitry, control circuitry) or solar elements (e.g., power converters, power distribution circuitry, batteries), or both. Implementing the panels in such rotatably deployable configurations may support increasing a surface area of the satellite available to support performance characteristics of the communications satellite, while maintaining a relatively compact shape that supports a relatively large quantity of such satellites being deployed from within a single launch vehicle fairing. Although some of the described techniques may be implemented in communications satellites, the described techniques may be applicable to other communication systems, such as ground-based antenna systems, portable antenna systems, vehicle-mounted antenna systems, and others.

Further scope of the applicability of the described methods and systems will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

FIG. 1 shows a diagram of a communication system that supports techniques for deployable-panel antennas in accordance with examples described herein.

FIG. 2 shows an example of a fairing configuration that supports techniques for deployable-panel antennas in accordance with examples as disclosed herein.

FIGS. 3A through 4B show an example of a satellite that supports techniques for deployable-panel antennas in accordance with examples as disclosed herein.

FIG. 5 shows an example of a signal processing architecture that supports techniques for deployable-panel antennas in accordance with examples as disclosed herein.

FIG. 6 shows a flowchart illustrating a method that support techniques for deployable-panel antennas in accordance with examples as disclosed herein.

### DETAILED DESCRIPTION

The described techniques relate to improved methods, systems, devices, and apparatuses for deployable-panel antennas. A communications device, such as a communications satellite, may be configured to communicate with or relay signals between other devices via wireless signaling using an antenna system of the communications device. For example, a satellite may be deployed in an orbital location or moving orbital configuration (e.g., a non-geostationary orbit (NGSO), such as a low Earth orbit (LEO) or a medium Earth orbit (MEO)), and may include an antenna system that implements a set of multiple antenna elements (e.g., direct-radiating antenna elements, a direct-radiating array) that, in some examples, may be configured to communicate signaling via one or more beamformed beams (e.g., receive beams, transmit beams) with the other devices. However, some implementations of such a set of antenna elements may occupy a relatively large surface area, including when such antenna elements are operated without a reflector.

Additionally, operation of such a set of antenna elements may be associated with relatively substantial power consumption, which may be supported by a relatively large solar array. In some cases, deploying such communications satellites may include enclosing a set of multiple such communications satellite within a fairing of a launch vehicle (e.g., a rocket), such that the communications satellites may be deployed from the fairing after launch of the launch vehicle into respective orbital paths at an altitude over Earth. Due to spatial constraints within the fairing, some implementations of communications satellites may have insufficient surface area to support a spatial distribution of antenna elements, or a relatively large solar array, or both.

In accordance with examples as disclosed herein, a communications satellite may include panels that are rotatably deployable to increase a surface area for implementing antenna elements, solar elements, or both. For example, such panels may each include a respective subset of the antenna elements of the communications satellite on one face of the panels and, in some examples, a respective set of solar elements to provide power for operating the communications satellite on an opposite face of the panels. For deployment, the panels may each be configured to rotate about a coupling axis (e.g., an axis extending from a body of the communications satellite) to a respective angular alignment. Thus, the panels may be stowed in a relatively compact configuration, which may be at least partially within a cross-sectional projection of a body of the communications satellite, and may be deployed in a deployed configuration (e.g., an expanded configuration, a circular configuration) associated with rotating the panels about the coupling axis. In the deployed configuration, the panels may form a polygonal or circular shape, such that a surface area available for antenna elements, solar panels, or both, is greater than the cross-sectional shape of the body portion, which may improve performance characteristics of the communications satellite.

In some cases, a body portion of such a communications satellite may also include a set of one or more antenna elements, or a set of one or more solar elements, or both. Further, the panels, a body portion, or a combination thereof may include circuitry configured to operate the antenna elements (e.g., signal processing circuitry, beamforming circuitry, control circuitry) or solar elements (e.g., power converters, power distribution circuitry, batteries), or both. Implementing the panels in such rotatably deployable configurations may support increasing a surface area of the satellite available to support performance characteristics of the communications satellite, while maintaining a relatively compact shape that supports a relatively large quantity of such satellites being deployed from within a single launch vehicle fairing. Although some of the described techniques may be implemented in communications satellites, the described techniques may be applicable to other communication systems, such as ground-based antenna systems, portable antenna systems, vehicle-mounted antenna systems, and others.

Aspects of the disclosure are initially described in the context of satellite communication systems. Aspects of the disclosure are further illustrated by and described with reference to fairing configurations, satellites, signal processing architectures, and methods that relate to techniques for deployable-panel antennas.

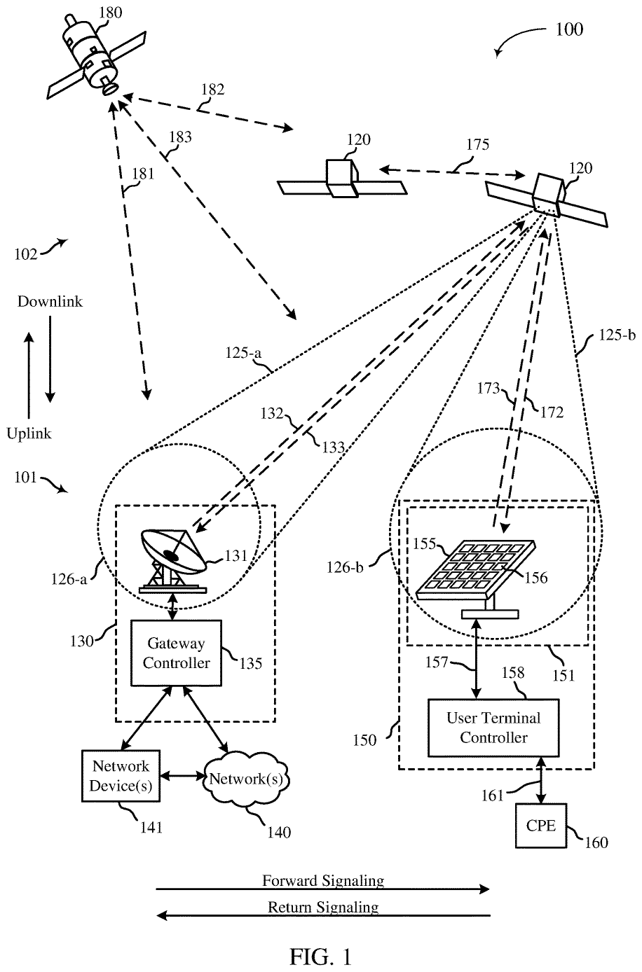

FIG. 1 shows a diagram of a communication system 100 (e.g., a satellite communication system) that supports techniques for deployable-panel antennas in accordance with examples as disclosed herein. A communication system 100 may use various architectures to support a communication service, such as an architecture that includes a ground segment 101 and space segment 102. A space segment 102 may include one or more satellites 120 (e.g., communications satellites). A ground segment 101 may include ground terminals, such as one or more user terminals 150 (e.g., service consumer terminals) and one or more gateway terminals 130 (e.g., access node terminals, network terminals, service provider terminals), as well as network devices 141 such as network operations centers (NOCs), satellite and gateway terminal command centers, and others. In some implementations, terminals of the communication system 100 (e.g., gateway terminals 130) may be communicatively coupled with each other, or with one or more networks 140, or a combination thereof (e.g., via a mesh network, via a star network, via a wired network, via a wireless network).

Satellites 120 may include any suitable type of satellite configured for wireless communication (e.g., for providing a communication service) with or between gateway terminals 130 and user terminals 150. In some examples, one or more of the satellites 120 (e.g., all of the satellites 120) may be in a respective orbit for which a position of the satellite 120 relative to Earth changes over time (e.g., an NGSO). In some other examples, one or more of the satellites 120 (e.g., all of the satellites 120) may be in a respective position relative to Earth, such that the one or more of the satellites maintain a same relative position to a point on Earth (e.g., a geostationary orbit). Although at least some techniques are described herein with reference to a satellite 120 being an example of a device that supports relaying communications between ground terminals, one or more techniques described herein may be applicable to other types of devices operable to relay signaling (e.g., between ground terminals), which may have a generally overhead location relative to ground terminals (e.g., a plane, an unmanned aerial vehicle, a drone, a dirigible), or may be ground-based relays, including mobile or stationary relay devices.

The communication system 100 may support uplink signaling (e.g., from the ground segment 101 to the space segment 102), downlink signaling (e.g., from the space segment 102 to the ground segment 101), crosslink signaling (e.g., between devices of the space segment 102, such as between satellites 120), or any combination thereof. The communication system 100 also may support forward signaling (e.g., from gateway terminals 130 to user terminals 150), and return signaling (e.g., from user terminals 150 to gateway terminals 130), among other signaling (e.g., signaling between gateway terminals 130, signaling between user terminals 150) or any combination thereof. For example, a satellite 120 may receive uplink signals 132 (e.g., forward uplink signals) from one or more gateway terminals 130, and also may transmit downlink signals 172 (e.g., forward downlink signals) to one or more user terminals 150, which may be associated with (e.g., include) relaying forward link signaling. Additionally, or alternatively, a satellite 120 may receive uplink signals 173 (e.g., return uplink signals) from one or more user terminals 150, and also may transmit downlink signals 133 (e.g., return downlink signals) to one or more gateway terminals 130, which may be associated with relaying return link signaling. Additionally, or alternatively, a first satellite 120 may transmit crosslink signals 175 that may be received by a second satellite 120, which may include forward crosslink signaling (e.g., between forward uplink signals 132 and forward downlink signals 172), return crosslink signaling (e.g., between return uplink signals 173 and return downlink signals 133), or a combination thereof.

Various physical layer modulation and coding techniques may be supported for the communication of signals between gateway terminals 130 and user terminals 150 (e.g., via one or more satellites 120), such as multi-frequency time-division multiple access (MF-TDMA), time division multiple access (TDMA), frequency division multiple access (FDMA), orthogonal frequency division multiple access (OFDMA), code division multiple access (CDMA), or any number of hybrid or other schemes known in the art. In various implementations, physical layer techniques may be the same for each of the signals 132, 133, 172, 173, and 175, or some of such signals may use different physical layer techniques than other such signals. A satellite 120 may support communications using one or more frequency bands, and any quantity of sub-bands thereof. For example, one or more of the satellites 120 may respectively support operations in any one or more of an E-band, a W-band, a V-band, a Ka-band, a K-band, a Ku-band, an X-band, a C-band, an S-band, an L-band, or a V-band, among other bands or combinations of bands.

A satellite 120 may include a system of one or more antennas (e.g., one or more antenna systems), such as a phased array antenna, a direct-radiating phased array antenna, a phased array fed reflector (PAFR) antenna, or any other components known in the art for transmission and/or reception of signals of a communication service. In some examples, an antenna system may support communication via one or more beamformed spot beams 125 (e.g., a spot beam associated with directional transmission, a spot beam associated with directional reception, a spot beam associated with directional transmission and directional reception), which may be referred to as beams, service beams, satellite beams, or any other suitable terminology. Signals may be passed via an array of feed elements of an antenna system (e.g., via a beamformer) of a satellite 120 to transmit or receive a spatial electromagnetic radiation pattern (e.g., scan volume) of the spot beams 125. In some examples, a spot beam 125 may use or be otherwise associated with a single carrier (e.g., one frequency or a contiguous frequency range).

In some examples, a spot beam 125 may be configured (e.g., by location, by frequency range, by polarization) to support only gateway terminals 130 (e.g., a single gateway terminal 130), in which case the spot beam 125 may be referred to as a gateway spot beam or a gateway beam (e.g., gateway spot beam 125-a). For example, a gateway spot beam 125-a may be configured to support one or more uplink signals 132 between the satellite 120 and a gateway terminal 130 (e.g., forward uplink signals, as a receive spot beam of the satellite 120), one or more downlink signals 133 between the satellite 120 and a gateway terminal 130 (e.g., return downlink signals, as a transmit spot beam of the satellite), or a combination thereof. In some examples, a satellite 120 may support a first gateway spot beam 125 (e.g., an uplink gateway spot beam, a forward gateway spot beam) for receiving uplink signals 132 (e.g., forward uplink signals, to output a forward uplink beam signal), and may support a second gateway spot beam 125 (e.g., a downlink gateway spot beam, a return gateway spot beam) for transmitting downlink signals 133 (e.g., return downlink signals, to obtain a return downlink beam signal). In various examples, such techniques may include gateway beams 125 that are aligned along the same direction from a satellite 120 (e.g., toward the same gateway terminal 130, for concurrently supporting forward and return traffic), or aligned along different directions from a satellite 120 (e.g., toward respective different gateway terminals 130 for forward and return traffic), or supported via different antenna systems (e.g., a reception antenna system and a transmission antenna system) or portions thereof of a satellite 120, or both.

In some examples, a spot beam 125 may be configured (e.g., by location, by frequency range, by polarization) to support only user terminals 150 (e.g., one or more user terminals 150), in which case the spot beam 125 may be referred to as a user spot beam or a user beam (e.g., user spot beam 125-b, which may be associated with a respective user spot beam coverage area 126-a). For example, a user spot beam 125-b may be configured to support one or more downlink signals 172 (e.g., forward downlink signals, as a transmit spot beam of the satellite 120), one or more uplink signals 173 (e.g., return uplink signals, as a receive spot beam of the satellite) between the satellite 120 and user terminals 150, or a combination thereof. In some examples, a satellite 120 may support a first user spot beam 125 (e.g., a downlink user spot beam, a forward user spot beam) for transmitting downlink signals 172 (e.g., forward downlink signals, to output a forward downlink beam signal), and may support a second user spot beam 125 (e.g., an uplink user spot beam, a return user spot beam) for receiving uplink signals 173 (e.g., return uplink signals, to obtain a return uplink beam signal). In various examples, such techniques may include user beams 125 aligned along the same direction from a satellite 120 (e.g., toward the same portion of a service area, for concurrently supporting forward and return traffic in a same area), or user beams 125 along different directions from a satellite 120 (e.g., toward respective different portions of a service area, for supporting forward and return traffic in different areas), or supported via different antenna systems (e.g., a transmission antenna system and a reception antenna system) or portions thereof of a satellite 120, or both.

In some examples, a spot beam 125 may be configured to service both user terminals 150 and gateway terminals 130. For example, a spot beam 125 may be configured to support any combination of downlink signals 172, uplink signals 173, uplink signals 132, or downlink signals 133 between a satellite 120 and user terminals 150 and gateway terminals 130. In some examples, a satellite 120 may use a spot beam 125 for transmitting crosslink signals 175, or for receiving crosslink signals 175, or both (not shown). Such techniques may be supported by a satellite 120 using a same crosslink spot beam for transmitting and receiving crosslink signals 175, or using a first crosslink spot beam for transmitting crosslink signals 175 and a second crosslink spot beam for receiving crosslink signals 175, which may be supported by a same antenna systems or different antenna systems of the satellite 120.

A spot beam 125 may support a communication service with target devices (e.g., user terminals 150, gateway terminals 130, satellites 120) that are located within a volume of a spot beam 125, such as being located in a spot beam coverage area 126, or projection thereof (e.g., at different distances from a plane or surface of the spot beam coverage area 126). A spot beam coverage area 126 may be defined by an area of the electromagnetic radiation pattern of the associated spot beam 125, as projected on the ground or other reference surface, having a signal characteristic (e.g., signal strength, signal-to-noise ratio (SNR), signal-to-interference-plus-noise ratio (SINR)) that is above or otherwise satisfies a threshold. A spot beam coverage area 126 may cover any suitable service area (e.g., circular, elliptical, hexagonal, local, regional, national, planar, non-planar) and may support a communication service with any quantity of target devices located in the spot beam coverage area 126, which may include target devices located within the associated spot beam 125 (e.g., within a volume of the associated spot beam 125), but not necessarily at the reference surface of a spot beam coverage area 126, such as airborne terminals or underwater terminals.

In some examples, a satellite 120 may support multiple beamformed spot beams 125 each associated with a respective spot beam coverage area 126, each of which may overlap or not overlap with another (e.g., adjacent) spot beam coverage area 126. For example, the satellite 120 may support one or more service areas (e.g., service coverage areas) using any quantity of spot beam coverage areas 126. A service area may be broadly defined as a coverage area from which, and/or to which, either a terrestrial transmission source, or a terrestrial receiver may participate in (e.g., transmit and/or receive signals associated with) a communication service via one or more satellite 120, and may be served by one or more spot beam coverage areas 126 via one or more satellites 120 (e.g., for a respective durations during which a satellite 120 in an NGSO is able to serve one or more spot beam coverage areas 126 that are at least partially overlapping with the service area). In some systems, the service coverage area for each communication link (e.g., a forward uplink coverage area, a forward downlink coverage area, a return uplink coverage area, and/or a return downlink coverage area) may be different.

User terminals 150 may include various devices configured to communicate signals with a satellite 120, or other target device, which may include fixed terminals (e.g., ground-based stationary terminals) or mobile terminals (e.g., terminals on boats, terminals on aircraft, terminals on ground-based vehicles), among other types of terminals. A user terminal 150 may communicate information via the satellite 120 or other target device, which may include communications via a gateway terminal 130 to a destination device such as a network device 141, or some other device or distributed server associated with a network 140. A user terminal 150 may communicate signals according to a variety of physical layer transmission modulation and coding techniques, including, for example, those defined with the DVB-S2, WiMAX, LTE, and DOCSIS standards, among other standards.

A user terminal 150 may include an antenna 155 that is configured for receiving downlink signals 172 (e.g., from a satellite 120), for transmitting uplink signals 173 (e.g., to a satellite 120), or both. An antenna 155 may be part of an antenna assembly 151 (e.g., a user terminal antenna assembly), which may also include various hardware for mounting or orienting the antenna 155. An antenna assembly 151 may also include circuits and/or processors for converting (e.g., performing frequency conversion, modulating/demodulating, multiplexing/demultiplexing, filtering, forwarding) between radio frequency (RF) communication signals (e.g., downlink signals 172, uplink signals 173) and user terminal communications signals 157 communicated between the antenna 155 and a user terminal controller 158. Such circuits and/or processors may be included in an antenna assembly 151, which may be referred to as an integrated antenna assembly or processor-integrated antenna assembly. Additionally, or alternatively, the user terminal controller 158 may include circuits for performing various RF signal operations (e.g., receiving, performing frequency conversion, modulating/demodulating, multiplexing/demultiplexing, etc.). The antenna assembly 151 may also be known as a satellite outdoor unit (ODU), and the user terminal controller 158 may be known as an indoor unit (IDU).

A user terminal 150 may be connected via a wired or wireless connection 161 to one or more instances of consumer premises equipment (CPE) 160, and may provide network access service (e.g., access to a network 140, Internet access) or other communication services (e.g., broadcast media, multicast media) to CPEs 160 via one or more devices of the communication system 100. CPEs 160 may include user devices such as, but not limited to, computers, local area networks, internet appliances, wireless networks, mobile phones, personal digital assistants (PDAs), other handheld devices, netbooks, notebook computers, tablet computers, laptops, display devices (e.g., TVs, computer monitors), printers, sensors, vehicles, and other equipment. CPEs 160 may also include any equipment located at a premises of a subscriber, including routers, firewalls, switches, private branch exchanges (PBXs), Voice over Internet Protocol (VOIP) gateways, among others. In some examples, the user terminal 150 supports two-way communications between one or more CPEs 160 and one or more networks 140 (e.g., via one or more satellites 120, via one or more gateway terminals 130).

A gateway terminal 130 may service uplink signals 132 and downlink signals 133 (e.g., to and from one or more satellites 120). Gateway terminals 130 may also be known as ground stations, gateways, or hubs. A gateway terminal 130 may include a gateway terminal antenna system 131 and a gateway controller 135 (e.g., an access node controller). A gateway terminal antenna system 131 may be two-way capable and designed with adequate transmit power and receive sensitivity to communicate reliably with one or more satellites 120. In some examples, a gateway terminal antenna system 131 may include a parabolic reflector with high directivity in the direction of a satellite 120 and low directivity in other directions. A gateway terminal antenna system 131 may include a variety of other configurations that support operating features such as high isolation between orthogonal polarizations, high efficiency in the operational frequency bands, low noise, and other features.

In some examples, a gateway terminal 130 (e.g., a gateway controller 135, an access node controller) may schedule traffic to user terminals 150. Additionally, or alternatively, traffic scheduling may be performed in other parts of communication system 100 (e.g., at one or more network devices 141, which may include network operations centers (NOC) and/or gateway command centers). A satellite 120 may communicate with a gateway terminal 130 by transmitting downlink signals 133, receiving uplink signals 132, or both via one or more spot beams 125 (e.g., a gateway spot beam 125-a, which may be associated with a respective gateway spot beam coverage area 126-a). A gateway spot beam 125-a may, for example, support a communications service for one or more user terminals 150 (e.g., relayed by the satellite 120), or any other communications between the satellite 120 and the gateway terminal 130.

A gateway terminal 130 may provide an interface between the network 140 and the satellite 120, and may be configured to relay information directed between the network 140 and one or more user terminals 150. A gateway terminal 130 may format information for delivery to respective user terminals 150. Additionally, or alternatively, a gateway terminal 130 may be configured to receive signals from the satellite 120 (e.g., from one or more user terminals 150) directed to a destination accessible via network 140. A gateway terminal 130 may also format the received signals for transmission to a network 140.

The network(s) 140 may be any type of network and can include, for example, the Internet, an Internet Protocol (IP) network, an intranet, a wide-area network (WAN), a metropolitan area network (MAN), a local-area network (LAN), a virtual private network (VPN), a virtual LAN (VLAN), a fiber optic network, a hybrid fiber-coax network, a cable network, a public switched telephone network (PSTN), a public switched data network (PSDN), a public land mobile network, and/or any other type of network supporting communications between devices as described herein. Network(s) 140 may include both wired and wireless connections as well as optical links. Network(s) 140 may connect one or more gateway terminals 130 with other gateway terminals 130 that may be in communication with the satellites 120 or with other satellites. One or more network device(s) 141 may be coupled with a gateway terminal 130 and may control aspects of the communication system 100. In various examples a network device 141 may be co-located or otherwise nearby a gateway terminal 130, or may be a remote installation that communicates with a gateway terminal 130 and/or network(s) 140 via wired and/or wireless communications link(s).

In some examples, the communication system 100 (e.g., a space segment 102) may implement a set (e.g., a constellation) of multiple satellites 120 to support a communications service. For example, service areas of such a communications service may be configured such that, at a given time, communications may be served by one or more satellites 120 passing over the service area (e.g., satellites 120 in respective NGSOs). In some examples, such techniques may also be supported by the communication system 100 including a satellite 180, which may be a satellite in a different orbit (e.g., a geostationary orbit) than the satellites 120. A satellite 180 may be implemented to support various techniques of the communication system 100. For example, a satellite 180 may be configured to support data signaling with or between gateway terminals 130 (e.g., via signals 181, which may include uplink signaling, downlink signaling, or both), with or between user terminals 150 (e.g., via signals 182, which may include uplink signaling, downlink signaling or both), or a combination thereof (e.g., as a relay between gateway terminals 130 and user terminals 150). Additionally, or alternatively, a satellite 180 may be configured to support data signaling with satellites 120 (e.g., via signals 183), including being implemented as a crosslink relay. Additionally, or alternatively, a satellite 180 may support transmitting configuration signaling, such as for configuring operations of gateway terminals 130 (e.g., via signals 181), for configuring operations of user terminals 150 (e.g., via signals 182), or for configuring operations of satellites 120 (e.g., via signals 183, for deploying or configuring operations of satellites 120, for configuring or adjusting orbital parameters of satellites), or any combination thereof.

In accordance with examples as described herein, one or more of the satellites 120 of a communication system 100 may include panels that are rotatably deployable to increase a surface area for implementing antenna elements (e.g., of an antenna array), solar elements (e.g., of a solar array), or both. For example, such panels may each include a respective subset of the antenna elements of the satellite 120 on one face of the panels (e.g., nadir faces) and, in some examples, a respective set of solar elements to provide power for operating the satellite 120 on an opposite face of the panels (e.g., zenith faces). For deployment, the panels may each be configured to rotate about a coupling axis (e.g., an axis extending from a body of the satellite 120) to a respective angular alignment (e.g., to deploy the antenna array).

Thus, the panels may be stowed in a relatively compact configuration, which may be at least partially within a cross-sectional projection of a body of the satellite 120, and may be deployed in a deployed configuration associated with rotating the panels about the coupling axis. In the deployed configuration, the panels may form a polygonal or circular shape, such that a surface area available for antenna elements, solar panels, or both, is greater than the cross-sectional shape of the body portion, which may improve performance characteristics of the satellite 120.

In some cases, a body portion of such a satellite 120 may also include a set of one or more antenna elements (e.g., of the antenna array), or a set of one or more solar elements, or both. Further, the panels, a body portion, or a combination thereof may include circuitry configured to operate the antenna elements (e.g., signal processing circuitry, beamforming circuitry, circuitry to operate the antenna elements collectively as an array) or solar elements (e.g., power converters, power distribution circuitry, batteries), or both. Implementing the panels in such rotatably deployable configurations may support increasing the surface area of the satellite 120 available to support performance characteristics of the satellite 120, while maintaining a relatively compact shape that supports a relatively large quantity of such satellites 120 being deployed from within a single launch vehicle fairing. For example, deploying satellites 120 may include enclosing the satellites 120 within a fairing of a launch vehicle, and launching the launching vehicle into space, such that the satellites 120 may be deployed from the fairing into respective orbital paths or slots. Implementing rotatably-deployable panels may support increasing the surface area of a satellite 120 without increasing a cross-sectional profile of the satellite 120, which may support launching a relatively large quantity of satellites 120 in a common fairing. That is, because a cross-sectional area of satellites 120 before deployment can be relatively compact, a given fairing may contain a relatively large quantity of satellites 120.

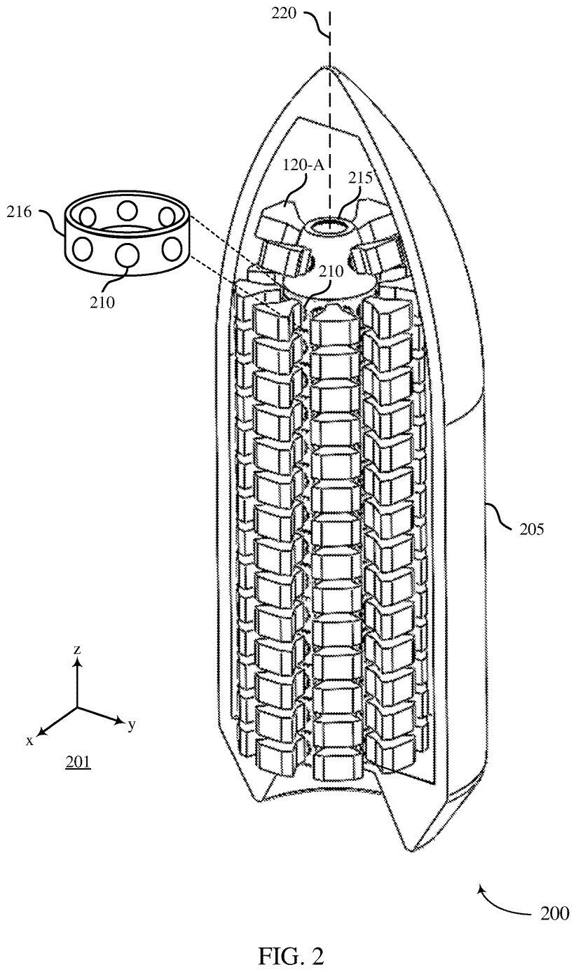

FIG. 2 shows an example of a fairing configuration 200 that supports techniques for deployable-panel antennas in accordance with examples as disclosed herein. The fairing configuration 200 may be implemented to deploy a set of satellites 120-a for operation in a communication system, such as a communication system 100. FIG. 2 illustrates the fairing configuration 200 in a trimetric view with a cross-sectional opening of a fairing 205, for viewing contents within the fairing 205. Aspects of fairing configuration 200 may be described with reference to the illustrated coordinate system 201 (e.g., a coordinate system of the fairing configuration).

A fairing 205 may be part of a launch vehicle (e.g., installed on a rocket system, not shown) that includes a propulsion system, a guidance system, and a payload. For example, a launch vehicle may implement a fairing 205 as part of the payload. In some examples, a fairing 205 may be configured according to a particular launch vehicle. In some cases, a fairing 205 may include a cylindrical structure (e.g., body) with a top that decreases in diameter (e.g. in accordance with a conical, cone-like, or other shape). For example, the cylindrical structure may have a diameter (e.g., in an xy-plane) that extends for a distance along the z-direction, and the top may have a diameter (e.g., in an xy-plane) that decreases along the z-direction. In an illustrative example, an interior of the cylindrical structure may have a diameter of 4.6 meters along a height of 6.7 meters. The fairing 205 may include a cavity to enclose objects to be deployed in Earth orbit, such as satellites 120-a.

The fairing 205 may include or enclose a mounting structure 215, which may be centrally fixed inside the fairing 205 along an axis 220 (e.g., a centerline, of the mounting structure 215, of the fairing 205). The mounting structure 215 may include a cylindrical portion with a diameter that extends for a distance along the z-direction. The mounting structure 215 may include a set of mounting ports 210 that are positioned on the mounting structure 215 radially about the axis 220 and axially along the axis 220. For example, the mounting ports 210 may be positioned circularly around the mounting structure 215. In some cases, the mounting structure 215 may include a set of one or more substructures 216 each associated with a subset of mounting ports 210. For example, each substructure 216 may be a cylindrical structure with mounting ports 210 distributed around an outer face of the cylindrical structure. In some examples, each substructure 216 may be implemented in accordance with a payload standard (e.g., in accordance with an evolved expendable launch vehicle (EELV) Secondary Payload Adapter (ESPA) standard).

The fairing configuration 200 may support (e.g., include) a set of satellites 120-a, with each satellite 120-a being connected to a respective mounting port 210. In some cases, a shape of the satellites 120-a may facilitate enclosing the satellites 120-a in the fairing 205. For example, because each satellite 120-a is mounted about the mounting structure 215 (e.g., radially), the fairing 205 may accommodate satellites 120-a having a relatively larger width at an end that is opposite from a connection to a port 210. Thus, in some implementations, each satellite 120-a may have a trapezoidal, curved, wedge-shaped, or arc-shaped profile in an xy-plane, with a projection thereof along the z-direction. By being configured with such shapes, a fairing 205 may be configured to enclose a relatively high quantity of satellites 120-a, and each satellite 120-a may have a relatively large cross-sectional area (e.g., in an xy-plane).

In some cases, satellites may be deployed in an NGSO, such as a LEO. In some such cases, there may be a desire to deploy a relatively high quantity of satellites to support a desired service area or signaling capacity in a communication system 100. However, implementing a relatively high quantity of satellites may, in some examples, involve a relatively high quantity of launch vehicles. Thus, implementing aspects of satellites 120-a (e.g., with a generally trapezoidal shape, with an antenna array having deployable panels) may enable a relatively greater quantity of the satellites 120-a with relatively high-performance antenna systems to be enclosed within the launch vehicle, thereby reducing a quantity of launch vehicles, which may be associated with reduced costs, among other advantages.

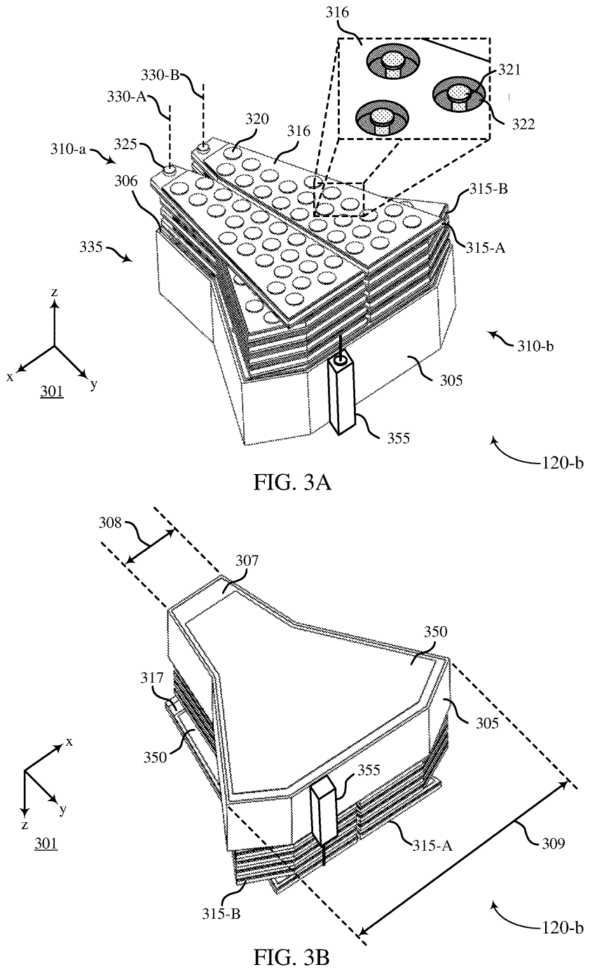

FIGS. 3A and 3B show an example of a satellite 120-b that supports techniques for deployable-panel antennas in accordance with examples as disclosed herein. Aspects of the satellite 120-b may be described with reference to the illustrated coordinate system 301 (e.g., a coordinate system of the satellite 120-b). For example, FIGS. 3A and 3B illustrate the satellite 120-b in opposite trimetric views that are rotated about the y-direction. FIGS. 3A and 3B illustrate the satellite 120- b in a compact configuration, before deployment of panels 315 of the satellite 120-b (e.g., associated with maintaining panels 315 in a confined orientation that is substantially within a projection of a body 305). Satellites 120-b may be deployed by a launch vehicle, such as in accordance with a fairing configuration 200, among other configurations.

The satellite 120-b may include a body 305 and a set of panels 315 that are rotatably coupled with the body 305. The body 305 may be configured to connect to a mounting port 210 of a mounting structure 215 (e.g., at an end toward the negative y-direction). The body 305 may have a shape that is generally trapezoidal (e.g., in an xy-plane). For example, the body 305 may have a first width (e.g., width 308) along the x-direction at a first end of the body 305 (e.g., a first end along the y-direction, and end for coupling with a port 210), and a second width (e.g., width 309) along the x-direction at a second end of the body 305 (e.g., opposite the first end). The body 305 may have a generally prismatic shape that includes a projection of the generally trapezoidal shape along the z-direction. At least a shell of the body 305 may be a made from a metal material (e.g., aluminum, titanium), and the body 305 may enclose at least a portion of circuitry for operating the satellite 120-b (e.g., control circuitry, signal processing circuitry), among other components (e.g., one or more thrusters for adjusting an orbital characteristic of the satellite 120-b, one or more angular momentum systems for adjusting an orientation of the satellite 120-b). In some examples, the body 305 may be shaped such that the panels 315 fit within a projection of the generally trapezoidal shape along the z-direction.

In some implementations, a body 305 may be omitted, and aspects of a satellite 120 or other antenna system may be distributed among panels 315 without a body 305. For example, such a satellite 120 or other antenna system may instead implement a single stack of panels 315 that are rotatably coupled with one another and configured to deploy into a deployed configuration. In some such examples, the satellite 120 or other antenna system may distribute control circuitry, signaling processing circuitry, or other circuitry among the stack of panels 315. In some examples, a body 305 may be replaced with a mounting system, such as a mounting system to attach to a vehicle, to a tripod, to a building, or to another structure for deploying an antenna system (e.g., a deployable-panel antenna array) in accordance with examples as disclosed herein.

The set of panels 315 may be rotatably coupled (e.g., with a body 305, with one another) via one or more rotary joints 325, along one or more coupling axes 330 (e.g., axes extending along the z-direction). For example, one or more rotary joints 325 may extend (e.g., along the z-direction) from a face 306 of the body 305 (e.g., a face in an xy-plane, a nadir face of the satellite 120-b) along a coupling axis 330, where a coupling axis 330 may extend from (e.g., perpendicularly) the face 306. In some cases, rotary joints 325 or coupling axes 330 may be located at the first end of the body 305 (e.g., a narrower end) to facilitate rotating panels 315 about a coupling axis 330 to form a generally circular or polygonal surface area. In some cases, rotary joints 325 may include rotating structures (e.g., hinges, bearings, bushings, sleeves, shafts), each of which may be coupled with or otherwise associated with a respective panel 315 and configured support rotation about a coupling axis 330. In some such cases, rotating structures of the rotating joints 325 may be cylindrical structures (e.g., or another shaped structure) configured to rotate about a coupling axis 330.

A satellite 120 may implement panels 315 in one or more stacks 310, for which each panel 315 may be located at a respective position (e.g., a fixed position, a distance) along the coupling axis 330. For example, each panel 315 may be associated with a respective xy-plane along the z-direction, such that the panels 315 of a stack 310 are offset from one another along the z-direction (e.g., in parallel xy-planes). In some examples, an offset between the panels 315 may support stacking the panels 315, such that a stack 310 of panels 315 may rotate about a coupling axis 330 without interfering (e.g., adversely contacting) with one another. In some cases, a face 316 of each panel 315 (e.g., a respective face in an xy-plane, a respective nadir face) may be fixed relative to (e.g., fixed perpendicularly to) a coupling axis 330 (e.g., in accordance with a planar constraint). In some examples, panels 315 may be implemented in a single stack 310 that is rotatably coupled (e.g., with a body 305, with one another) about a single coupling axis 330. For example, a stack 310 may be coupled via a single rotary joint 325 (e.g., including one or more rotating structures). In some other examples, a set of panels 315 of a satellite 120 or other implementation may be divided among two or more stacks 310 that are rotatably coupled with a body 305 about two or more coupling axes 330. For example, in the satellite 120-b, panels 315 of a stack 310-a may be coupled along a coupling axis 330-a (e.g., including one or more rotary joints 325), and panels 315 of a stack 310-b may be coupled along a coupling axis 330-b.

In some cases, panels 315 may have a generally trapezoidal, arc-shaped, wedge-shaped, or triangular shape (e.g., in an xy-plane). For example, a panel 315-a may have a shape that is generally trapezoidal in an xy-plane and projected along the z-direction. In another example, a panel 315-b may have a shape that is generally wedge-shaped (e.g., triangular) in an xy-plane and projected along the z-direction. In some cases, panels 315 may be configured to have different shaped structures to support a set of panels 315 forming a generally circular or polygonal shape in a deployed configuration. In some implementations, panels 315 may be configured to have different shapes, which may be associated with panels 315 being associated with one or more stacks 310 that fit at least partially (e.g., substantially, more than 80%, more than 90%, more than 95%) within a projection of the body 305 (e.g., in an xy-plane) along the z-direction. That is, panels 315 may be arranged within a cross-sectional profile of the body 305 that is perpendicular to the coupling axis 330. For example, at least some of the panels 315 may have an area that is within an area of the body 305 from a top view or bottom view of the satellite 120-b (e.g., along the z-direction). In some examples, at least a portion of the panels 315 may be made from a metal material (e.g., aluminum, titanium), and may, in some examples, enclose at least a portion of implementing circuitry (e.g., control circuitry, signal processing circuitry) within the panels 315.

The satellite 120-b may also include an array of antenna elements 320. In various implementations, antenna elements 320 may be located on panels 315, or on a combination of panels 315 and a body 305, where applicable. For example, each panel 315 may include a respective subset of antenna elements 320 that are implemented on a face 316 of the respective panel 315 (e.g., a nadir face of the panel 315). In some examples, the body 305 may also include subset of antenna elements 320 implemented on the face 306 (e.g., a nadir face of the body 305). In some examples, faces 316 and the face 306 may be in respective xy-planes, such that the faces 316 and the face 306 are parallel (e.g., in accordance with a constrained parallel arrangement). The antenna elements 320 may (e.g., collectively) support communicating signaling between the satellite 120-b and other devices, such as uplink signals 132 and 173, downlink signals 133 and 172, crosslink signals 175, or any combination thereof. In some examples, the antenna elements 320 may be configured to support such signaling via any quantity of one or more beamformed beams 125 (e.g., via a single beam 125, via multiple beams 125 concurrently, via beams 125 that are electronically steered along a signaling direction by beamforming circuitry). In some examples, antenna elements 320 may be configured to operate in a particular bandwidth (e.g., as L-band antenna elements).

In some implementations, the antenna elements 320 may each include an antenna feed 321 and a feed cavity 322 (e.g., a reflecting cavity). An antenna feed 321 may be configured to transmit and receive signaling reflected (e.g., redirected) off a feed cavity 322. In some other examples, an antenna element 320 may omit a feed cavity 322, such as with a direct-radiating antenna element 320 or direct-radiating antenna feed 321. In some cases, each antenna element 320 may include at least one transmission element and at least one reception element (e.g., as separate elements, as a combined transceiver element), which may be configured to support bi-directional communication between the satellite 120-b and other devices.

The satellite 120-b may also include solar panels 350 (e.g., solar elements, or a solar array). In various examples, solar panels 350 may be implemented on the panels 315, or on the body 305, or a combination thereof. For example, each panel 315 may include one or more solar panels 350 implemented on a respective face 317 (e.g., a face in an xy-plane, opposite a face 316, face opposite antenna elements 320, a zenith face) of the respective panel 315. Additionally, or alternatively, a body 305 (e.g., where applicable) may include a set of one or more solar panels 350 implemented on (e.g., within) a face 307 (e.g., opposite the face 306, a zenith deck, a zenith face of the body 305). In some examples, the faces 317 and the face 307 may be in xy-planes, such that the faces 317 and the face 307 are parallel (e.g., in accordance with a constrained parallel relationship).

In some cases, the panels 315 may have a configuration (e.g., a material configuration, a shape configuration) to dissipate heat associated with implementing antenna elements 320, solar panels 350, or supporting circuitry within the panels 315, among other heat sources. For example, exposed surfaces facing outward from panels 315 or the body 305 (e.g., along one or more directions in an xy-plane, along the z-direction) may be configured for radiant heat transfer from the satellite 120-b. In some examples, because rotary joints 325 may be a thermal choke point, such surfaces may be configured on both the panels 315 and the body 305.

Solar panels 350 may be configured to provide power for the satellite 120-b based on receiving incident solar power and converting the solar power to electrical power. For example, the solar panels 350 may power operations of the satellite 120-b, such as operating the antenna elements 320 (e.g., transmitting and receiving signaling), operating actuators 335 for deploying or collapsing the panels 315, for steering the satellite 120-b (e.g., using one or more angular momentum systems), among other applications. In some examples, the body 305, one or more panels 315, or a combination thereof may include one or more batteries for storing power provided by the solar panels 350. The satellite 120-b may utilize power stored in the one or more batteries for operating the satellite 120-b. In some cases, the body 305, one or more panels 315, or a combination thereof may include conductors for coupling such batteries with the solar panels 350. For example, the panels 315 may include the one or more conductors running between the solar panels 350 implemented at the panels 315 and the one or more batteries implemented at the body 305, and such conductors may extend at least partly through the one or more rotary joints 325.

In some cases, the satellite 120-b may include signal processing circuitry. For example, the body 305, one or more panels 315, or a combination thereof may include circuitry to support signal processing, control, power distribution, or other functions. In some cases, the satellite 120-b may include an antenna 355, separate from the array of antenna elements 320. In some examples, an antenna 355 may be associated with a different bandwidth (e.g., a Ka band), and may located outside a cross-sectional profile of the body 305 or the panels 315 (e.g., in an undeployed condition, in a deployed condition, or both), which may support signaling to or from the satellite 120-b in various scenarios, including for scenarios in which the array or antenna elements 320 do not support communications. In some other examples, an antenna 355 may be omitted.

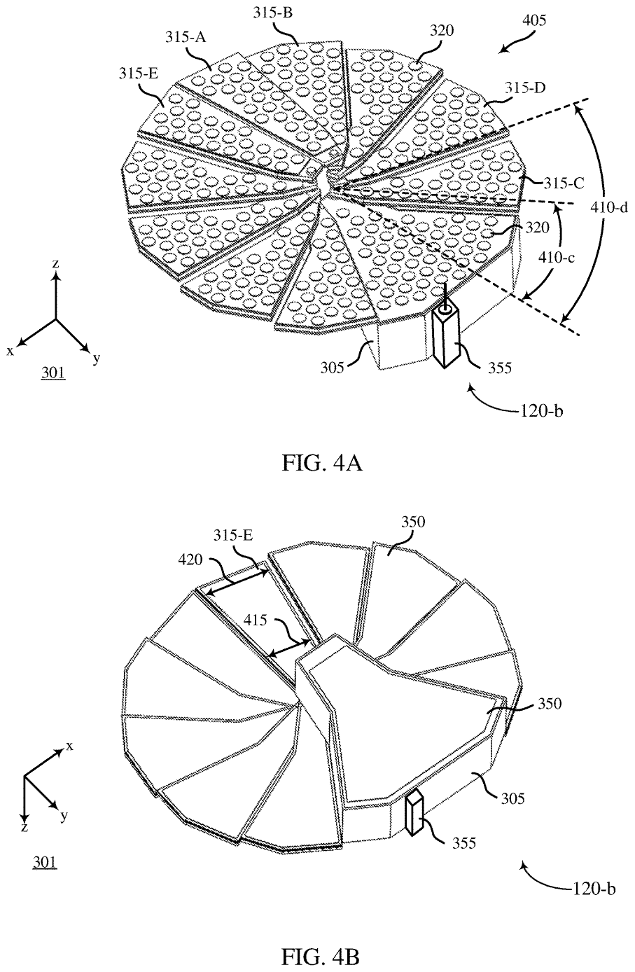

FIGS. 4A and 4B illustrate the satellite 120-b in a deployed configuration, after deployment of panels 315 of the satellite 120-b (e.g., associated with rotating panels 315 about the coupling axes 330). For example, the satellite 120-b may be configured to be launched (e.g., into low Earth orbit) in the compact configuration, as illustrated in FIGS. 3A and 3B. After launch (e.g., when deployed in along an orbital path) the satellite 120-b may be configured to be deployed in the deployed configuration, as illustrated in FIGS. 4A and 4B.

To deploy the panels 315 of the satellite 120-b, one or more actuators (e.g., actuators 335) may be configured to rotate the panels 315 about the coupling axes 330, which may include actuating one or more rotary joints 325 or an actuator (e.g., a motor, a spring release) in the body 305. For example, each panel 315 may be configured to rotate to or by a respective deployment angle 410 (e.g., rotating a panel 315-c by a deployment angle 410-c, rotating a panel 315-d by a deployment angle 410-d). In the deployed configuration, the set of panels 315 may form a circular or polygonal shape (e.g., when viewed along the z-direction), such that the set of antenna elements 320 form an array 405 (e.g., an antenna array, a direct radiating array). In some cases, the satellite 120-b may be configured to switch between the compact configuration and the deployed configuration based on one or more conditions monitored at the satellite 120-b or based on a command from a communication system. For example, the satellite 120-b may switch from the compact configuration to the deployed configuration based on identifying that the satellite 120-b is disconnected from a port 210 and clear of a fairing 205, or identifying that the satellite 120-b has entered a desired orbital path, among other examples. In some cases, the satellite 120-b may include one or more propulsion components (e.g., thrusters) and one or more attitude adjustment components (e.g., an angular momentum system, flywheels) to adjust a positioning and orientation of the satellite 120-b. For example, one or more propulsion components, one or more attitude adjustment components, or a combination thereof may enable adjustment of the satellite 120-b along its orbital path (e.g., a speed along an orbital path, a direction of an orbital path). Additionally, or alternatively, one or more propulsion components, one or more attitude adjustment components, or a combination thereof may enable alignment of an array 405 of antenna elements 320 (e.g., a z-direction of the satellite 120-b) along a direction toward a target service area.

In some implementations, one or more rotating structures of the rotating joints 325 may be configured to rotate to a respective deployment angle 410, such that a first rotating structure may support rotation to a first deployment angle 410, a second rotating structure may support rotation to a second deployment angle 410, and so on. In some implementations, a second rotating structure may rotate to a second deployment angle 410 based on a first rotating structure rotating to a first deployment angle 410, such that the second deployment angle is dependent on the first deployment angle 410. For example, a first panel 315 may be rotated by 30° relative to the body 305, and a second panel 315 may be rotated by 30° relative to the first panel 315, such that the overall deployment angle of the second panel 315 is 60°. In some other implementations, a second rotating structure may rotate to a second deployment angle 410 independently from a first rotating structure rotating to a first deployment angle 410, such that the second deployment angle 410 is implemented independently from the first deployment angle 410.

In some cases, a satellite 120 may include multiple stacks of panels 315. For example, the satellite 120-b may include a first stack of panels 315 and a second stack of panels 315, each configured to rotate about a respective coupling axis 330 (e.g., coupling axis 330-a and coupling axis 330-b). Implementing multiple stacks of panels 315 may enable a relatively smaller offset between panels 315 along the z-direction. For example, with a single stack of panels 315 (e.g., for a given total quantity of panels), a distance along the z-direction between a top panel 315 of the stack and a bottom panel 315 of the stack, or the body 305, may be relatively large. However, with two stacks of panels 315 for implementing the same quantity of panels 315 at the satellite 120-b, a distance along the z-direction between a top panel 315 of a first stack and a bottom panel 315 of the first stack, or the body 305, may be relatively lower. Implementing a reduced distance between panels 315 may improve communications performance of the satellite 120-b by supporting a smaller difference in signal propagation path lengths (e.g., along the z-direction) between antenna elements 320 of the array 405 (e.g., between antenna elements 320 of a top panel 315 and antenna elements 320 of a bottom panel 315 or the body 305).

In some cases, a shape of the panels 315 may be defined by a projection of the body 305 (e.g., along the z-direction) and a rotational expansion about the body 305 (e.g., about one or more coupling axes 330). For example, the panels 315 may be a generally trapezoidal shape, such that a panel 315-e may have a width 415 at a first end of the panel 315-e (e.g., a radially inward end) and a width 420 at a second end of the panel 315-e (e.g., a radially outward end) that is greater than the width 415.

The one or more rotating joints 325, or the body 305, or a combination thereof may include one or more actuators 335 configured to deploy the set of panels 315. For example, the one or more actuators 335 may be configured to rotate the one or more rotating joints 325, thereby rotating one or more panels 315 about a coupling axis 330. In some implementations, the one or more actuators 335 may be configured to rotate rotating structures of the one or more rotating joints 325. In some cases, the one or more actuators 335 may include one or more springs configured to rotate one or more panels 315 about a coupling axis 330. For example, such springs may be held in a constrained (e.g., compressed, torqued) condition when the satellite 120-b is in the compact configuration, then released (e.g., with a pin mechanism, with a release mechanism) when the satellite 120-b is deployed to the deployed configuration. Additionally, or alternatively, the one or more actuators 335 may include one or more motors configured to rotate one or more panels 315 about a coupling axis 330. In some implementations, the one or more actuators 335 may be configured to rotate each panel 315 to a respective deployment angle 410. For example, the one or more actuators 335 may be configured to independently rotate each rotating structure of the one or more rotating joints 325 to the respective deployment angles 410. In some other examples, the one or more actuators 335 may be configured to rotate the one or more rotating joints 325 such that the rotating structures may reach the respective deployment angles 410 based on the rotating structures being dependent on one another. For example, the panel 315-a may be rotated to its deployment angle 410, which may pull the panel 315-b to its deployment angle 410 (e.g., as a result of a mechanical stop between the panel 315-a and the panel 315-b), and so on.

The ability to switch from a compact configuration to a deployed configuration may facilitate enclosing satellites 120-b within a fairing 205 for deployment. For example, a fairing 205 may have a limited storage capacity (e.g., enclosed volume), but there may be a desire to implement a relatively large quantity of satellites within the fairing 205. Implementing satellite 120-b in a compact configuration may facilitate a relatively high quantity of satellites 120-b being enclosed within a fairing 205, because a volume of satellites 120-b in the compact configuration (e.g., trapezoidal or other compact prismatic shapes) may be packed in a fairing 205 relatively efficiently. Additionally, because the satellite 120-b is configured to deploy panels 315 (e.g., of one or more stacks) about a single axis (e.g., with constrained planar relationships, with a single rotational degree of freedom), an array 405 may be deployed with relative simplicity, reducing a risk of deployment errors.

In some cases, an array 405 of antenna elements 320 (e.g., of a set of panels 315) may be implemented on a vehicle, such as a ground-based vehicle (e.g., a truck), a water-based vehicle (e.g., a boat, a submarine), or an air-based vehicle (e.g., an airplane, a helicopter). In some other cases, the array 405 may be implemented as a mobile unit, such as a unit that may be mounted on a tripod or other mounting structure, on a building, or on a person (e.g., on a backpack, as a hand-held unit), among other implementations. For example, other implementations of an array 405 of antenna elements 320 may include various examples of panels 315 that are configured to rotatably deploy about one or more coupling axes 330 to increase a surface area for implementing the antenna elements 320.

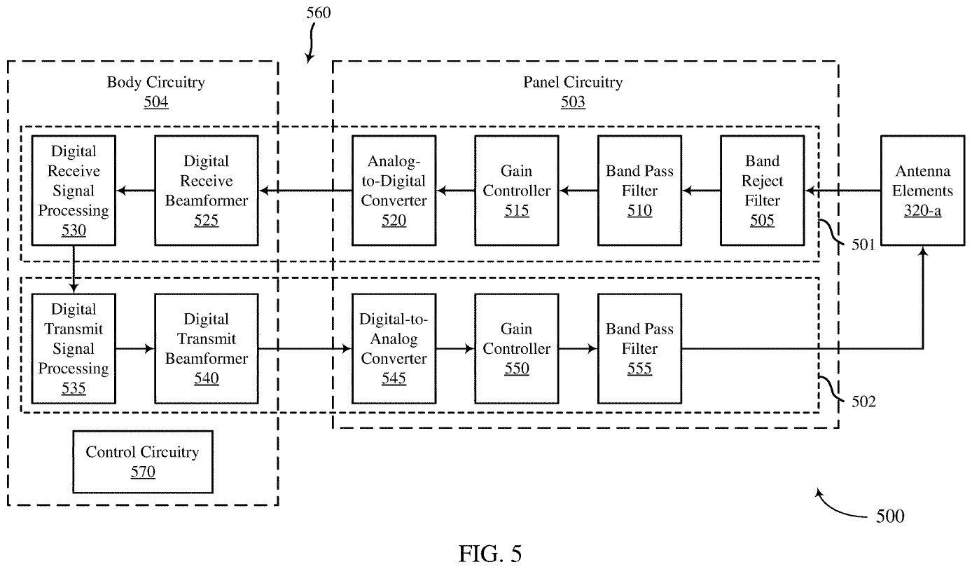

FIG. 5 shows an example of a signal processing architecture 500 that supports techniques for deployable-panel antennas in accordance with examples as disclosed herein. The signal processing architecture 500 may be implemented in a satellite 120 to support operations of an array 405 (e.g., collective operations of a set of antenna elements 320). For example, the signal processing architecture 500 illustrates an example of components (e.g., signal processing circuitry) of a receive path 501 and a transmit path 502, which may be distributed between one or more panels 315 and a body 305 to support signaling via the array 405. Although the signal processing architecture 500 illustrates an example of components that may support such signaling, other architectures in accordance with the described techniques may include one or more of the illustrated components in a different order, may omit one or more of the illustrated components, or may include one or more additional components in accordance with the described techniques for an antenna system with a deployable array 405.

In the example of signal processing architecture 500, respective subsets of components of both the receive path 501 and the transmit path 502 may be included in panel circuitry 503, which may be located in one or more panels 315 (e.g., distributed or divided among the same panels 315 as the antenna elements 320 that are supported by the components, distributed or divided among different panels 315 than the antenna elements 320 that are supported by the components, or a combination thereof). Further, respective subsets of components of both the receive path 501 and the transmit path 502 may also be included in body circuitry 504, which may be located in a body 305. The receive path 501 and the transmit path 502 may be coupled with antenna elements 320-a, which may refer to a collective set of multiple antenna elements 320 (e.g., at least a portion of the antenna elements 320 of an array 405) that are located on one or more panels 315. In some implementations, such an array 405 may also include antenna elements 320 located on a body 305 (not shown), in which case the components of a receive path 501 and a transmit path 502 for at least those antenna elements 320 on the body 305 may all be located within the body 305.

In general, signal processing circuitry to support signaling (e.g., reception, transmission, or both) via an array 405 may include analog-to-digital conversion circuitry, digital-to-analog conversion circuitry, frequency conversion circuitry, filtering circuitry, amplification circuitry, beamforming circuitry, demodulation circuitry, modulation circuitry, control circuitry, or any combination thereof, among other examples of circuitry. In the described architecture having deployable panels 315, such circuitry may be distributed among panels 315, or between panels 315 and a body 305, or within a body 305 in accordance with various design tradeoffs. For example, some components (e.g., analog components) may be located relatively closely to antenna elements 320 (e.g., antenna elements 320-a in panels 315) to reduce signal noise or to distribute heat generation, whereas some other components (e.g., digital processing components) may be centrally located (e.g., in a body 305) to support aspects of centralized processing, such as beamforming or other collective signal processing applicable to the set of antenna elements 320 of an array 405.

An interface between panel circuitry 503 and body circuitry 504 may include various examples of signal paths 560, which may include portions between panels 315 (e.g., between adjacent panels 315 along a coupling axis 330), or between panels 315 and a body 305, or any combination thereof. Signal paths 560 may be implemented within, through, or along (e.g., outside of) one or more rotary joints 325. In some examples, at least some of the signal paths 560 may be configured for conveying analog signaling, digital signaling, or a combination thereof. Additionally, or alternatively, at least some of the signal paths 560 may be configured for conveying power, such as conveying power between components of the signal processing architecture 500 and solar panels 350 or batteries, or between batteries distributed among panels 315 and a body, or between solar panels 350 on panels 315 and one or more batteries in a body, among other examples (e.g., as power distribution signal paths). Signal paths 560 may include conductive lines (e.g., wires, cables), optical lines (e.g., fiber optic lines), or any combination thereof, to support a given conveyance. In some implementations, signal paths 560 may extend, at least partially, through rotary joints 325 (e.g., through a passage of the rotary joints, via a slip ring).

A receive path 501 may include various components that support signal reception (e.g., directional reception, via an array 405, at a satellite 120), including reception via the antenna elements 320-a. For example, each of the antenna elements 320-a may receive a respective electromagnetic signal that is converted by the antenna element 320-a to an electrical signal (e.g., an analog electrical signal, a component signal of the antenna element 320-a), and the electrical signals of the antenna elements 320-a may be passed to the receive path 501. Along the receive path 501, such electrical signals may be passed through a band reject filter 505 to reject signal components within a bandwidth corresponding to the band reject filter 505, through a band pass filter 510 to reject signal components outside a bandwidth corresponding to the band pass filter 510, and through a gain controller 515 to adjust (e.g., increase, amplify, attenuate) a strength of the electrical signals. Such processed electrical signals may be passed through an analog-to-digital converter 520 to support digital signal conveyance and processing.

In some examples, including circuitry of an analog-to-digital converter 520 in one or more panels 315 (e.g., as part of panel circuitry 503) may support conveying digital signaling of the receive path 501 via signal paths 560 (e.g., via rotary joints 325), which may reduce attenuation, reduce noise sensitivity, reduce a quantity or quality (e.g., size, conductivity, shielding) of signal paths 360, or both compared to conveying analog receive signaling. In some implementations, the signal processing architecture 500 may include a separate signal path 560 for each of the antenna elements 320-a to carry corresponding digital signaling from the analog-to-digital converter 520. In some other implementations, digital or analog signaling for multiple antenna elements 320-a (e.g., for respective sets of antenna elements 320-a of a given panel 315) may be multiplexed to be conveyed on a shared signal path 560 (e.g., a signal path 560 per panel, among other examples), which may involve time domain multiplexing (TDM), frequency domain multiplexing (FDM), code division multiplexing (CDM), or other multiplexing techniques.

In the body circuitry 504, the receive path 501 may include a digital receive beamformer 525, which may receive the digital component signals associated with at least the antenna elements 320-a (e.g., and any antenna elements 320 on the body 305, where applicable) and perform various directional reception techniques (e.g., to support reception associated with any quantity of one or more beams 125). For example, for each of one or more receive beams 125 (e.g., for each of one or more reception directions), the digital receive beamformer 525 may apply a respective gain, time offset, phase offset, or any combination thereof (e.g., in the digital domain) to one or more of (e.g., each of) the digital component signals and combine (e.g., add) the processed signals to generate a beam signal associated with the receive beam 125 (e.g., associated with the reception direction). In some examples, such techniques (e.g., application of a time offset, application of a phase offset) may account for signal propagation path length differences associated with different positions (e.g., along the z-direction, of different panels 315) of antenna elements 320-a, which may be configured internally to the digital receive beamformer 525 (e.g., in accordance with configured positions or distances along the z-direction) or based on configuration signaling (e.g., based on detected differences in time-of-arrival of a reference signal transmitted by a configuration entity, such as a gateway terminal 130, a satellite 180, or another satellite 120). Such beam signal(s) for any quantity of one or more beams 125 may be passed to digital receive signal processing 530, which may perform operations such as frequency conversion, demodulation, signal extraction, signal insertion, or other techniques, before being passed to the transmit path 502.

A transmit path 502 may include various components that support signal transmission (e.g., via an array 405, at a satellite 120), including transmission via the antenna elements 320-a. For example, in the body circuitry 504, beam signals received from the receive path 501 (e.g., from the digital receive signal processing 530, one or more beam signals for relaying) may be passed to digital transmit signal processing 535, which may perform operations such as signal insertion, modulation, frequency conversion, or other techniques, before being passed to a digital transmit beamformer 540. The digital transmit beamformer 540 may perform various directional transmission techniques (e.g., to support transmission associated with any quantity of one or more beams 125, which may be the same quantity of transmit beams 125 as receive beams 125 or a different quantity). For example, for each of one or more transmit beams 125 (e.g., for each of one or more transmission directions, which may be different than or the same as the reception directions), the digital transmit beamformer 540 may apply a respective gain, time offset, phase offset, or any combination thereof (e.g., in the digital domain) to the corresponding beam signal to generate respective digital component signals for each of the antenna elements 320 (e.g., at least antenna elements 320-a) for the transmit beam 125 (e.g., associated with the transmission direction). As in the digital receive beamformer 525, such techniques at the digital transmit beamformer 540 may also account for signal propagation path length differences associated with different positions of antenna elements 320-a. For each of the antenna elements 320-a, the corresponding digital component signals for multiple beams 125 may be combined, such that each of the antenna elements 320-a may support transmitting electromagnetic signaling for some or all of the configured transmit beams 125.

In some examples, including circuitry of a digital-to-analog converter 545 in one or more panels 315 (e.g., as part of panel circuitry 503) may support conveying digital signaling of the transmit path 502 via signal paths 560 (e.g., via rotary joints 325), which may reduce attenuation, reduce noise sensitivity, reduce a quantity or quality (e.g., size, conductivity, shielding) of signal paths 360, or both compared to conveying analog transmit signaling. In some implementations, the signal processing architecture 500 may include a separate signal path 560 for each of the antenna elements 320-a to carry corresponding digital signaling from the digital transmit beamformer 540. In some other implementations, digital or analog signaling for multiple antenna elements 320-a (e.g., for respective sets of antenna elements 320-a of a given panel 315) may be multiplexed to be conveyed on a shared signal path 560 (e.g., a signal path 560 per panel, among other examples), which may involve time domain multiplexing (TDM), frequency domain multiplexing (FDM), code division multiplexing (CDM), or other multiplexing techniques.

At the panel circuitry 503, the combined digital component signals may be passed through a digital-to-analog converter 545 to generate electrical component signals for each of the antenna elements 320-a, which may then be passed through a gain controller 550 to adjust (e.g., increase, amplify, attenuate) a strength of the electrical component signals, and through a band pass filter 555 to reject signal components outside a bandwidth corresponding to the band pass filter 555. The filtered component signals may then be passed to the antenna elements 320-a, which may convert the electrical component signals into electromagnetic signals transmitted by the antenna elements 320-a (e.g., to form the one or more transmit beams 125).

Although the signal paths 560 of the signal processing architecture 500 illustrate an example division of components of a receive path 501 and a transmit path 502 between panel circuitry 503 and body circuitry 504, such components, or components of different signal processing architectures, may be arranged differently. For example, body circuitry 504 may be omitted (e.g., for implementations that lack a body 305), such that signal processing circuitry may be distributed among one or more panels 315. In some other examples, panel circuitry 503 may be omitted, such that signal processing circuitry may be included in body circuitry 504, and signal paths 560 may convey analog electrical signaling directly from antenna elements 320-a.

In some other examples, at least a portion of beamforming circuitry (e.g., of a digital receive beamformer 525, of a digital transmit beamformer 540, or both) may be included in panel circuitry 503. For example, beamforming circuitry may be distributed among one or more panels 315, including implementations in which each panel 315 includes the beamforming circuitry associated with all of the antenna elements 320-a located on the panel 315. Such implementations may support beam signals being conveyed digitally to each of the panels 315 via signal paths 560, which may use various multiplexing techniques to reduce a quantity of signal paths 560. In some other examples, beamforming circuitry may be omitted, and the antenna elements 320 (e.g., the antenna elements 320-a and antenna Substitute Specification-Clean elements 320 on a body 305, where applicable) may be configured for receiving or transmitting signaling along a single direction (e.g., without electronic steering, along the z-direction of the satellite 120 or array 405, in accordance with a plane wave). Similar to techniques described for a digital receive beamformer 525 or a digital transmit beamformer 540, such techniques for plane wave signaling may also account for signal propagation path length differences associated with different positions of antenna elements 320-a (e.g., by adding a respective time delay for antenna elements 320-a of a given panel 315 based on its position along a coupling axis 330).

In some cases, the signal processing architecture 500 may be controlled by one or more controllers of a satellite 120 or other device that includes the signal processing architecture 500. For example, a satellite 120 or other device may include control circuitry 570 (e.g., of or otherwise coupled with the signal processing architecture 500), which may be included in body circuitry 504 (where applicable) or another portion of the device (e.g., in panel circuitry 503, distributed among body circuitry 504 and panel circuitry 503). In some examples, control circuitry 570 may be configured to support beamforming or other operations of the signal processing architecture 500, such as establishing beam directions, gains, offsets, or other signal processing (e.g., based on a configuration at the control circuitry 570, based on commands received by the control circuitry 570). In some examples, the control circuitry 570 may also be configured to control one or more propulsion components of the satellite 120, or one or more attitude adjustment mechanisms of the satellite 120, or a combination thereof (e.g., to coordinate beamforming with a position or alignment of the satellite 120). Additionally, or alternatively, control circuitry 570 may be configured to control actuators 335 of the satellite 120, such that the control circuitry 570 is operable to facilitate deploying the panels 315 of the satellite 120. The control circuitry 570 may include any quantity of one or more processors and one or more memory devices, as well as other circuitry that may support the control circuitry 570 being configured to support performing various aspects of the described techniques.

Implementing a satellite 120 in accordance with examples disclosed herein may support implementing a relatively greater quantity of antenna elements 320-a for a given size (e.g., cross-sectional size) of a satellite 120. For example, a satellite 120 may be efficiently enclosed within a fairing 205 of a launch vehicle, then deployed and expanded to a deployed configuration, in which the satellite 120 may reveal a set of antenna elements 320-a to form an array 405. The satellite 120 may utilize the signal processing architecture 500, among other architectures, to support receiving and transmitting signaling via the deployed array 405.

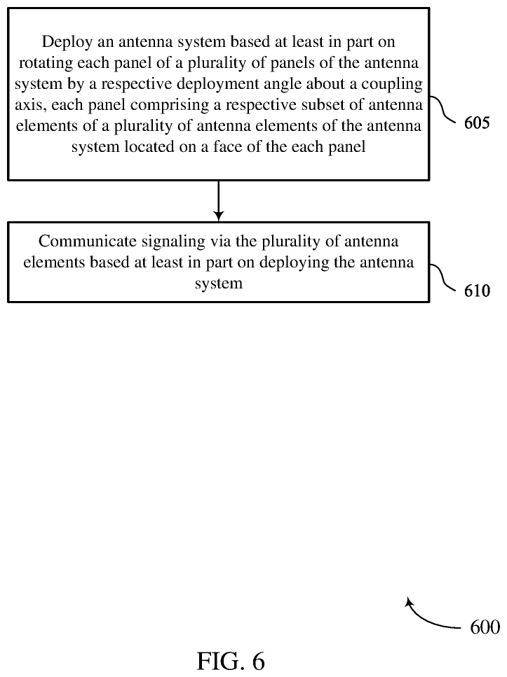

FIG. 6 shows a flowchart illustrating a method 600 that supports techniques for deployable-panel antennas in accordance with examples as disclosed herein. The operations of the method 600 may be implemented by a satellite 120 or other communications device, or its components, as described herein. For example, the operations of the method 600 may be performed by a satellite 120 as described with reference to FIGS. 1 through 5, or other device that includes an antenna array 405. In some examples, a communication system 100, a satellite 120, or another device may execute a set of instructions to control the functional elements of a satellite 120 or other device to perform the described functions. Additionally, or alternatively, a satellite 120 or other device may perform aspects of the described functions using special-purpose hardware.

At 605, the method may include deploying an antenna array (e.g., an array 405) (e.g., of a satellite 120) based at least in part on rotating each panel 315 of a plurality of panels 315 of the antenna array by a respective deployment angle 410 about a coupling axis 330, each panel 315 comprising a respective subset of antenna elements 320 of a plurality of antenna elements 320 of the antenna array located on a face 316 of the each panel 315. In some examples, aspects of the operations of 605 may be performed by a deployment component, such as one or more actuators 335.

At 610, the method may include communicating signaling via the plurality of antenna elements 320 (e.g., via the array 405) based at least in part on deploying the antenna array. In some examples, aspects of the operations of 610 may be performed by a communication component, such as components of the signal processing architecture 500.

In some examples, an apparatus (e.g., a satellite 120 or other apparatus) as described herein may perform a method or methods, such as the method 600. The apparatus may include features, circuitry, logic, means, or instructions (e.g., a non-transitory computer-readable medium storing instructions executable by a processor), or any combination thereof for performing aspects of the present disclosure.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The detailed description set forth above in connection with the appended drawings describes examples and does not represent the only examples that may be implemented or that are within the scope of the claims. The term “example,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with one or more processors (e.g., a processing system), which may include one or more of general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer readable medium. Other examples and implementations are within the scope of the disclosure and appended claims. For example, due to the nature of software, functions described herein can be implemented using software executed by one or more processors, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include random access memory (RAM), read-only memory (ROM), electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A satellite comprising:
an antenna array comprising a plurality of antenna elements:
a plurality of panels rotatably coupled with one another via one or more rotary joints along a coupling axis, the plurality of panels arranged in a stack and offset from one another along the coupling axis, and each panel comprising a respective subset of the plurality of antenna elements arranged on a face of the each panel that is perpendicular to the coupling axis; and
one or more actuators configured for deploying the plurality of panels wherein, for deploying the plurality of panels the one or more actuators are configured to rotate each of the plurality of panels about the coupling axis by a respective deployment angle.

2. (canceled)

3. The satellite of claim 1, wherein each panel is located at a respective fixed position along the coupling axis that is offset from others of the plurality of panels along the coupling axis.

4. The satellite of claim 1, wherein the antenna array is a direct radiating array.

5. The satellite of claim 1, further comprising:
a body, wherein the plurality of panels are rotatably coupled with the body and the coupling axis extends from a face of the body.

6. The satellite of claim 5, wherein, for each panel, the face of the each panel is parallel with the face of the body.

7. The satellite of claim 5, further comprising:
a plurality of second panels rotatably coupled with the body via one or more second rotary joints along a second coupling axis that extends from the face of the body, the plurality of second panels arranged in a second stack and offset from one another along the second coupling axis, and each second panel comprising a respective second subset of the plurality of antenna elements arranged on a face of the each second panel that is perpendicular to the second coupling axis; and
one or more second actuators configured for deploying the plurality of second panels, wherein, for deploying the plurality of second panels, the one or more second actuators are configured to rotate each of the plurality of second panels about the second coupling axis by a respective second deployment angle.

8. The satellite of claim 5, further comprising:
a second subset of the plurality of antenna elements on the face of the body from which the coupling axis extends.

9. The satellite of claim 5, wherein the body comprises signal processing circuitry operable for communicating signaling via the plurality of antenna elements.

10. The satellite of claim 9, wherein the signal processing circuitry comprises analog-to-digital conversion circuitry for communicating signaling from the respective subset of the plurality of antenna elements of the each panel, digital-to-analog conversion circuitry for communicating signaling to the respective subset of the plurality of antenna elements of the each panel, or a combination thereof.

11. The satellite of claim 9. wherein the signal processing circuitry comprises beamforming circuitry operable to support forming one or more beams using the plurality of antenna elements.

12. The satellite of claim 9, further comprising:
a plurality of signal paths between the signal processing circuitry and respective second signal processing circuitry in each of the plurality of panels, each of the plurality of signal paths extending at least in part through the one or more rotary joints.

13. The satellite of claim 12, wherein the plurality of signal paths comprise:
one or more first signal paths for carrying communications signaling, one or more second signal paths for carrying control signaling associated with controlling operations of the respective second signal processing circuitry, or a combination thereof.

14. The satellite of claim 5, further comprising:
one or more batteries located in the body of the satellite; and
one or more conductors operable to couple the one or more batteries with one or more solar panels located on the plurality of panels, each of the one or more conductors extending at least in part through the one or more rotary joints.

15. The satellite of claim 14, further comprising:
one or more second solar panels arranged on a second face of the body opposite the face of the body from which the coupling axis extends, the one or more second solar panels operable to couple with the one or more batteries.

16. The satellite of claim 5, wherein in an undeployed condition, the plurality of panels are arranged within a cross-sectional profile of the body perpendicular to the coupling axis.

17. The satellite of claim 16, wherein the cross-sectional profile has a first width, perpendicular to the coupling axis, at a first end from which the coupling axis extends that is narrower than a second width at a second end opposite the first end.

18. The satellite of claim 1, wherein each panel further comprises:
a respective set of one or more solar panels arranged on a second face of the each panel opposite the face of the each panel.

19. The satellite of claim 18, wherein each panel further comprises:
a respective set of one or more batteries operable to couple with the respective set of one or more solar panels.

20. The satellite of claim 1, wherein each panel further comprises:
respective signal processing circuitry operable for communicating signaling via the respective subset of the plurality of antenna elements.

21. The satellite of claim 20, wherein, for each panel of the plurality of panels, the respective signal processing circuitry comprises analog-to-digital conversion circuitry for communicating signaling from the respective subset of the plurality of antenna elements of the each panel, digital-to-analog conversion circuitry for communicating signaling to the respective subset of the plurality of antenna elements of the each panel, or a combination thereof.

22. The satellite of claim 20, wherein, for each panel of the plurality of panels, the respective signal processing circuitry comprises beamforming circuitry operable to support forming one or more beams using the respective subset of the plurality of antenna elements of the each panel.

23. The satellite of claim 1, wherein each antenna element of the plurality of antenna elements comprises a transmission element, a reception element, or a combination thereof.

24. The satellite of claim 1, wherein a first panel of the plurality of panels has a different shape than a second panel of the plurality of panels.

25. The satellite of claim 1, wherein the one or more actuators comprise:
one or more motors operable for deploying the plurality of panels.

26. The satellite of claim 1, wherein the one or more actuators comprise:
one or more springs operable for deploying the plurality of panels.

27. The satellite of claim 1, wherein the plurality of antenna elements are associated with a first bandwidth, the satellite further comprising:
a second antenna associated with a second bandwidth and located outside a first cross-sectional profile of the plurality of panels in an undeployed condition and outside a second cross-sectional profile of the plurality of panels in a deployed condition.

28-48. (canceled)
